(19) United States
(12) Patent Application Publication
(10) Pub. No.: US 2005/0035602 A1
(43) Pub. Date: Feb. 17, 2005

(54) Tidal generator

(76) Inventor: Timothy Alan Gard, Eden, NY (US)

Correspondence Address: Mr. Timothy A. Gard, 2748 West Church Street, Eden, NY, 14057, US

(21) Appl. No.: 10/640,522

(22) Filed: Aug. 11, 2003

(51) Int. Cl. H02P 9/04; F03B 13/10; F03B 13/12

(52) U.S. Cl. 290/53

(57) ABSTRACT

The basic function of this device is to use gravity effects on a fluid to cause energy to be developed in a manor different than the present hydro systems, alleviating the mechanical losses present in their design, as well as the limitations of placement, and layout that cause unnatural disturbances in surrounding natural systems. This design allows the device to be placed effectively on a low level system as well as a high, and still produce an effective output. This is accomplished by ganging low level hydro elevation differences. Territorial elevation differences such as Lake Erie versus Lake Ontario can be used for energy Production as well as tidal changes, as in the Bay of Fundy.

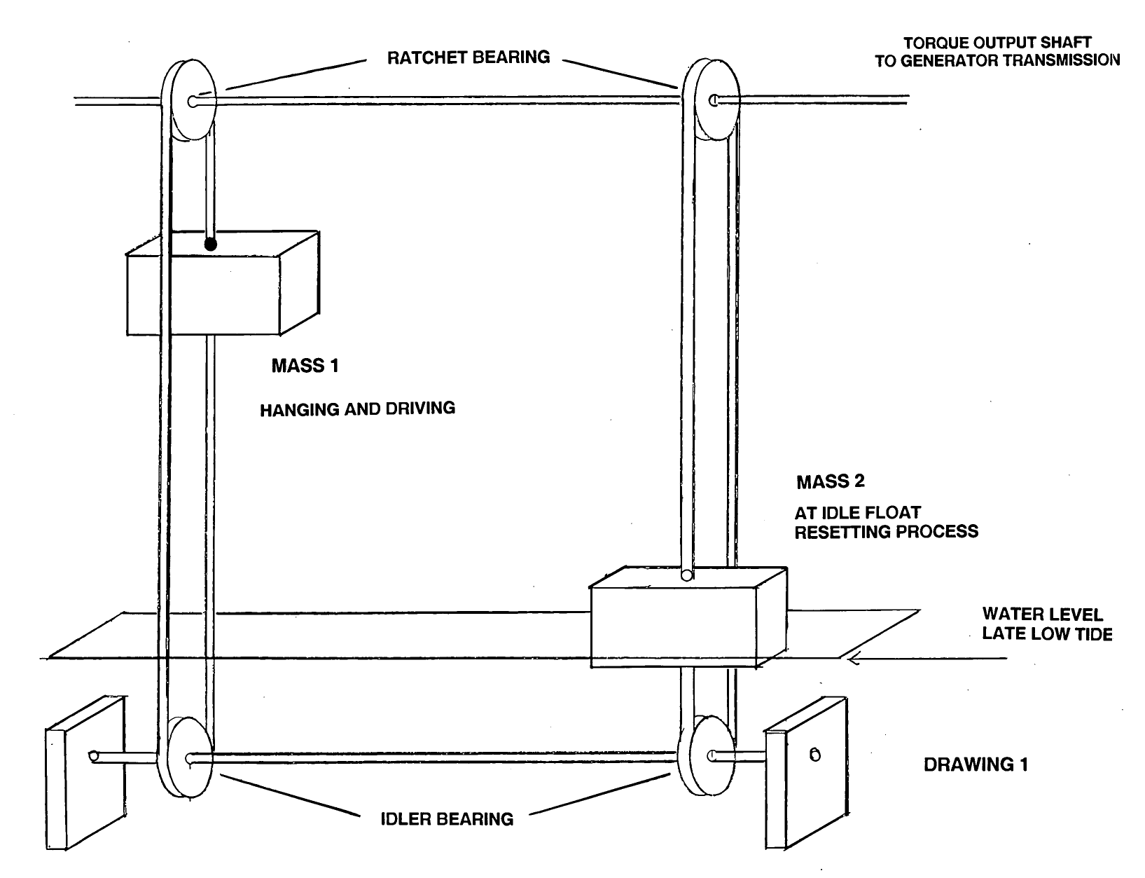

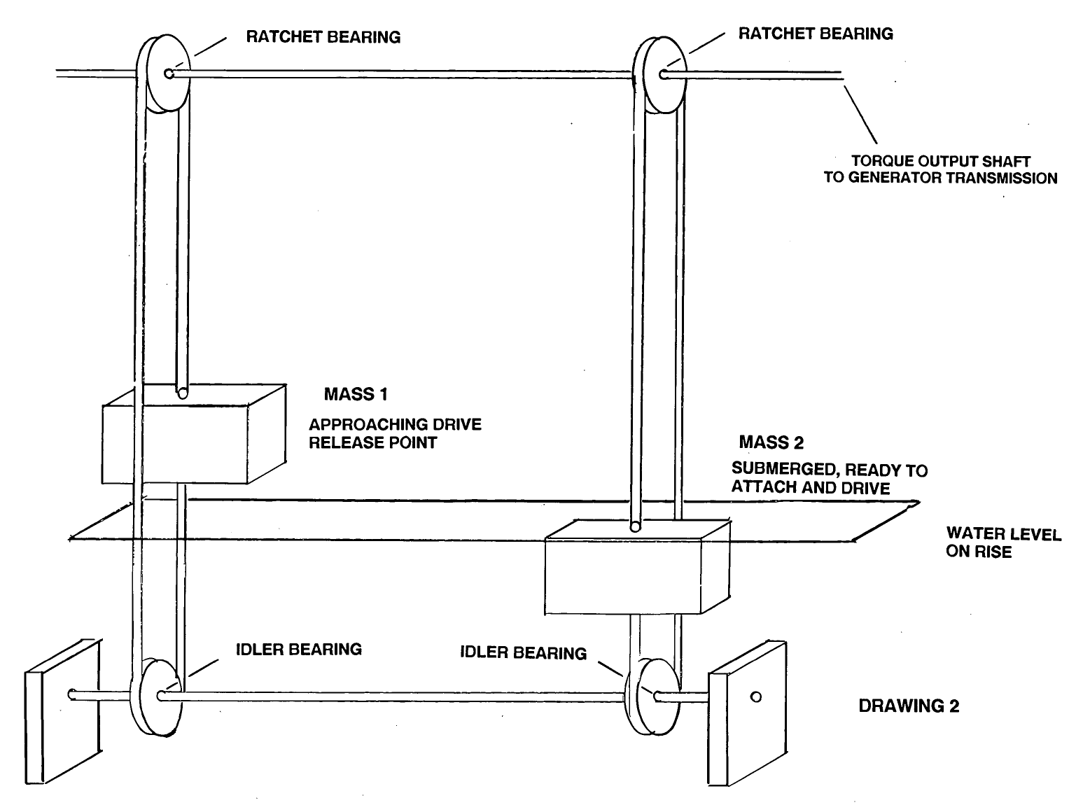

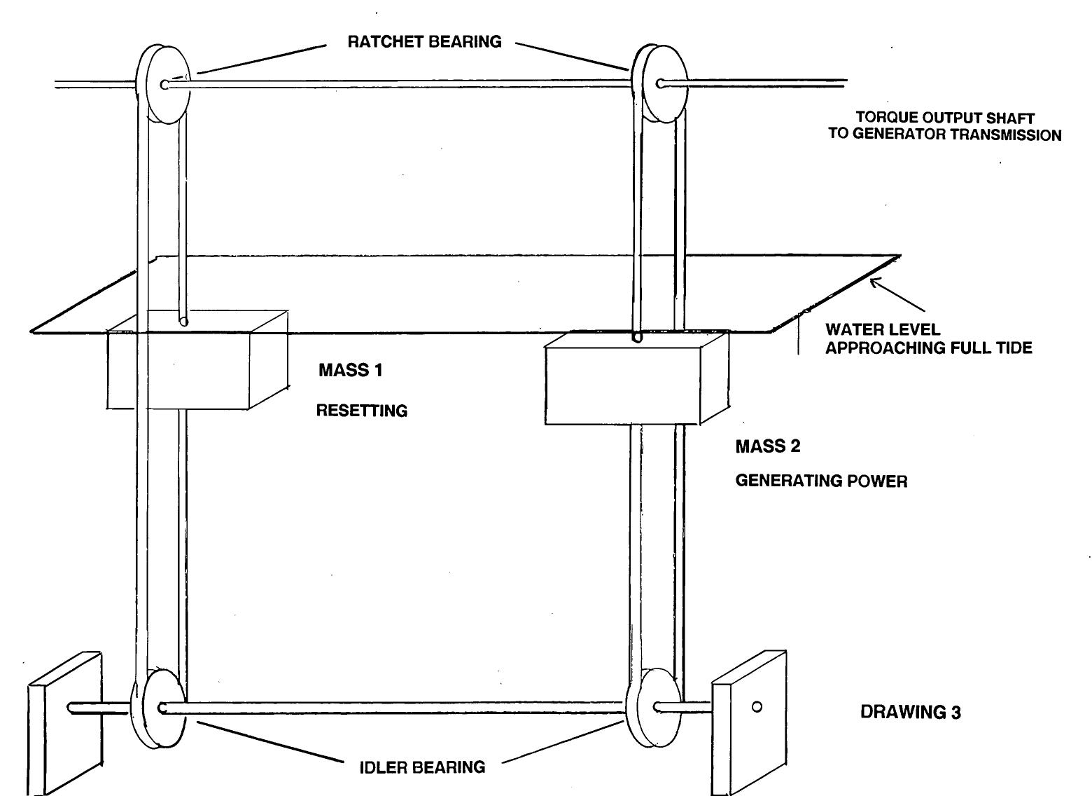

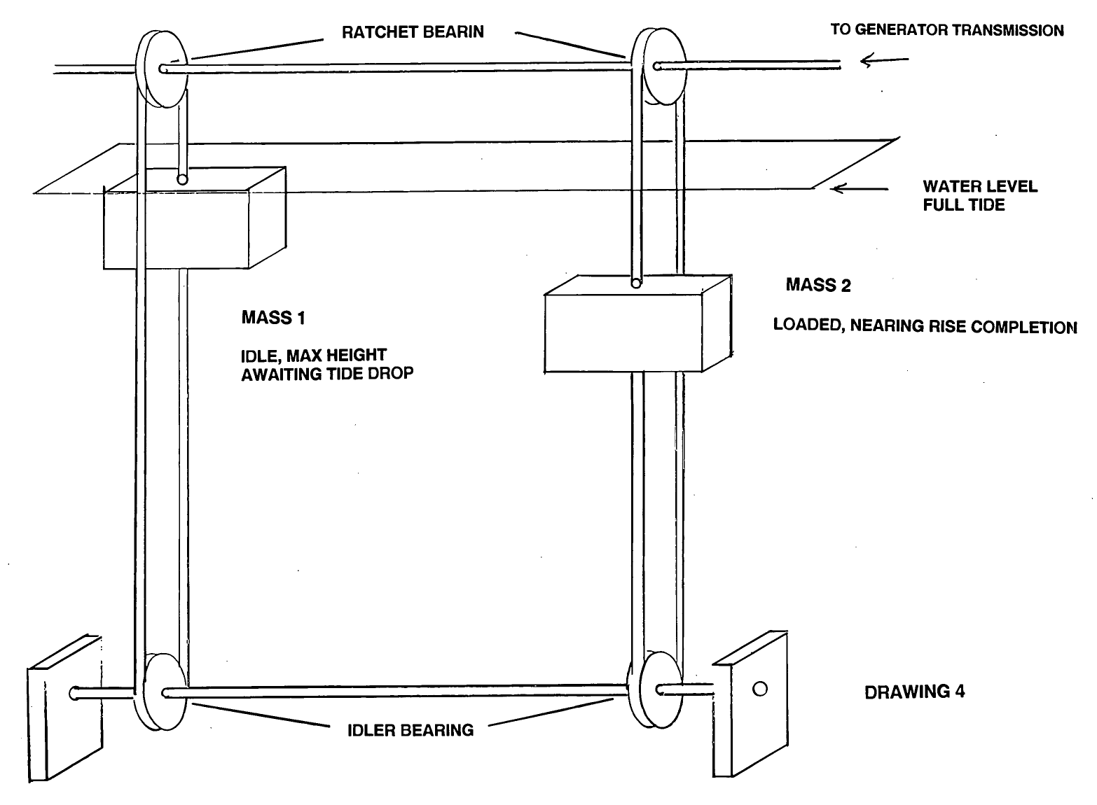

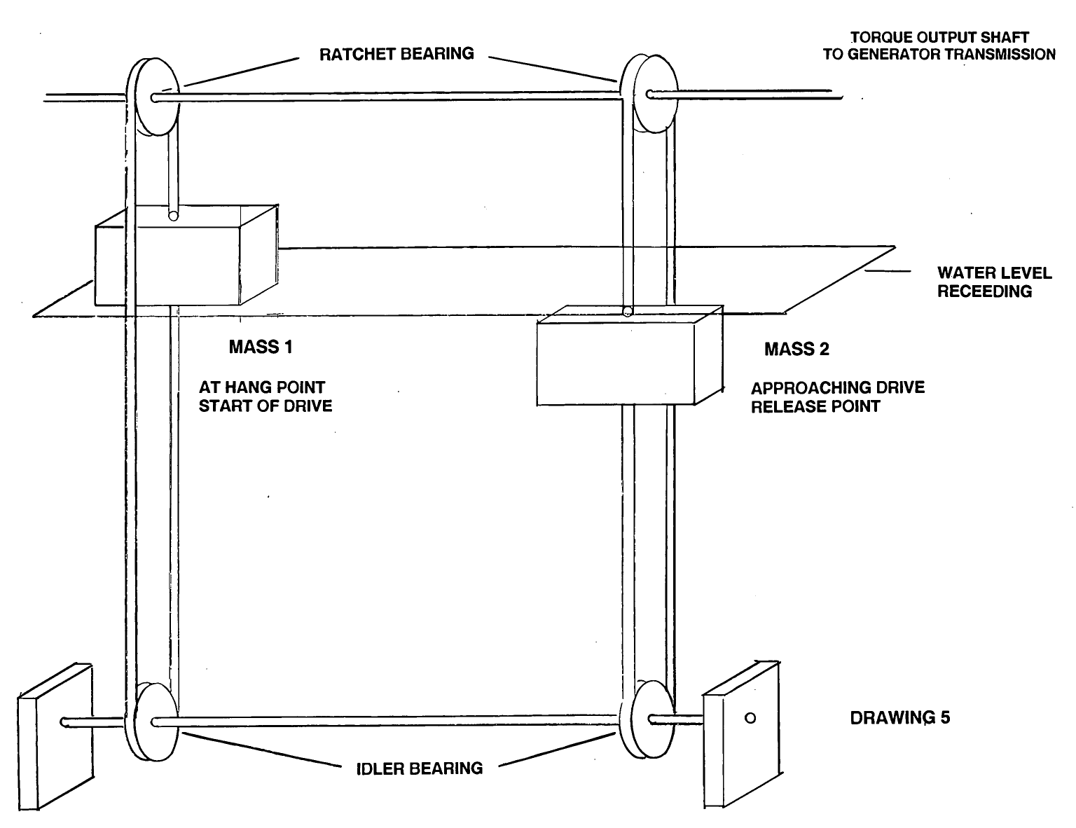

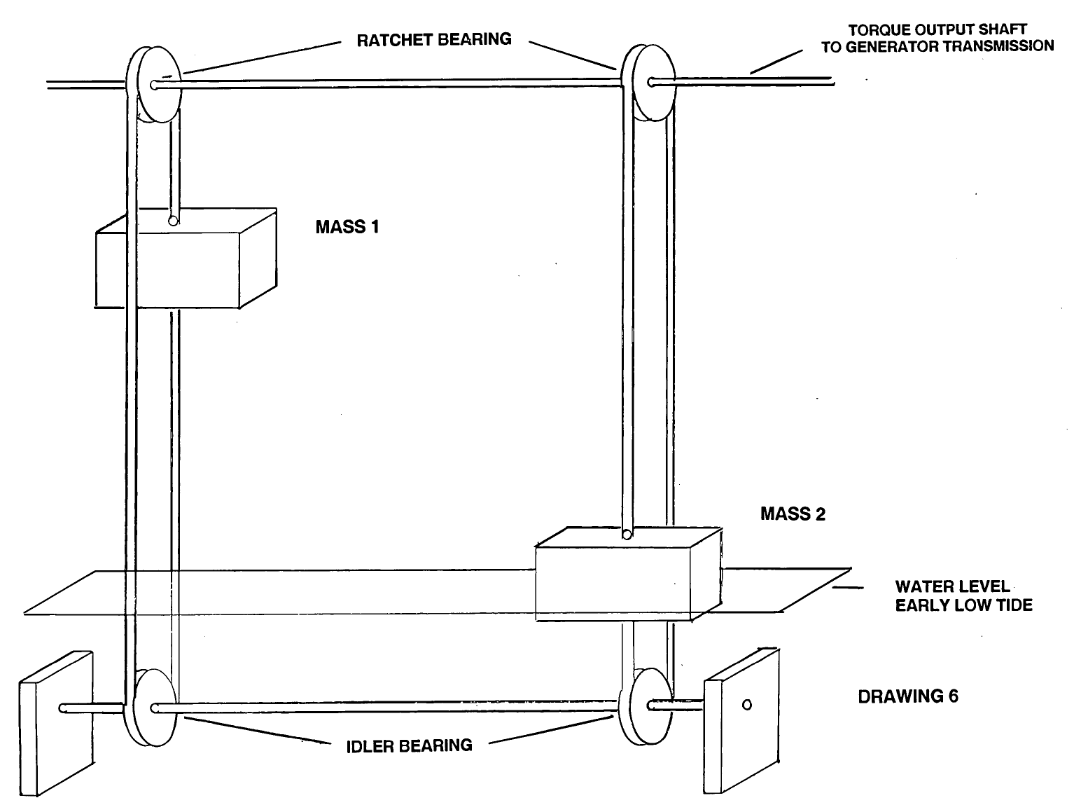

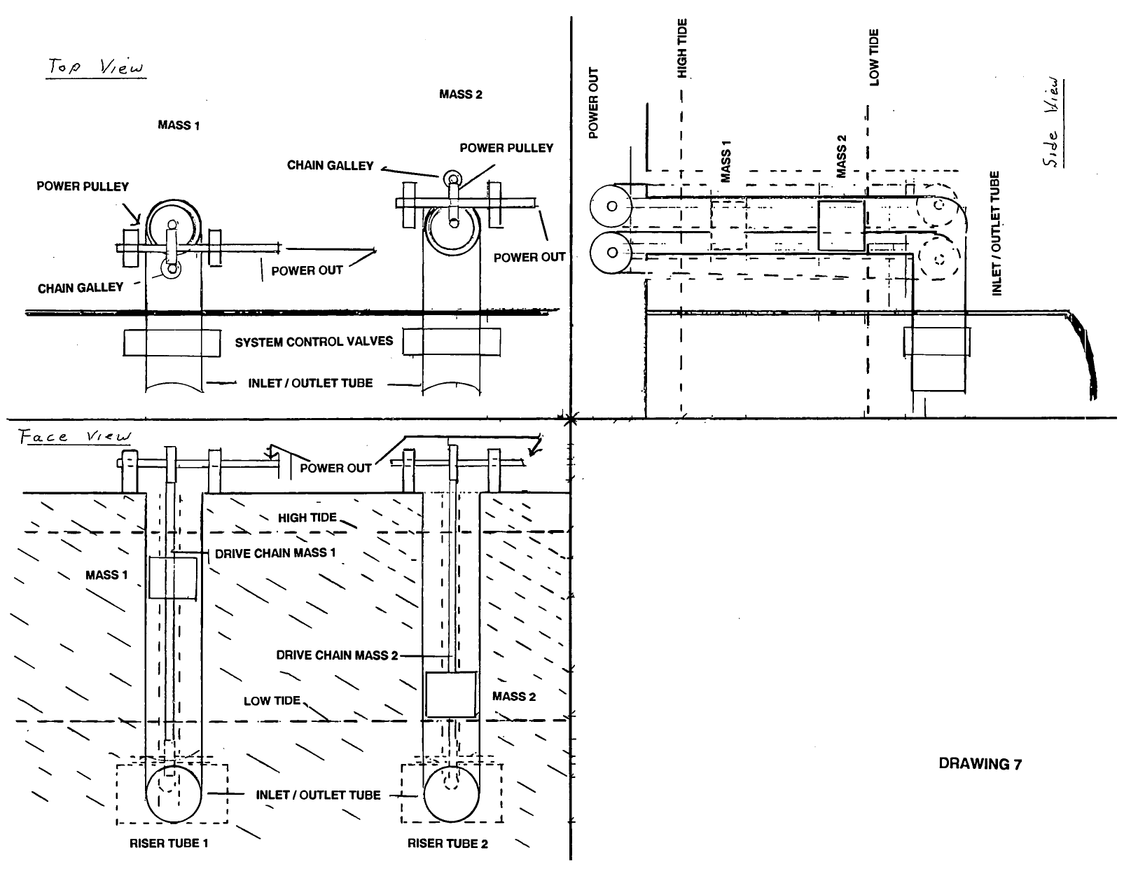

### BACKGROUND OF THE INVENTION

The background of this device relates to the fact that state of the art devices of similar power generation systems function at a dismal 15% efficiency. Studying these designs shows an inherent system flaw that bars these systems from ever accomplishing a higher efficiency. The process of accelerating any mass requires energy usage. This is one of the main drawbacks of our old fashioned power generation systems. They only use a small fraction of the available energy, as well as requiring very specific parameters for function, such as a large elevated body of water. The design of the tidal power generation device uses the overall mass of the water itself as well as the motion. By using the mass, we can accomplish efficiencies of estimated 80% or better overall instead of the dismal 15% we now consider to be adequate. And the system can use water at sea level, quite abundant on Earth today.

### SUMMARY OF THE INVENTION

The primary objective of this invention is to provide a more efficient means of generating electric power for general usage. By using the natural tide movements of our planet, we can harness energy at greater levels than ever before accomplished. This energy is a natural and constant functioning device. It can be gathered and used in this manor without detrimental impact on the environment in its development. The potential quantities would also allow our progression into a society that is not dependant on fossil fuels. We would not have to destroy our planet in order to progress.

The system also allows for a much less costly construction process because large reservoirs would be unnecessary due to the nature of using a standing column of water instead of a fast moving mass. Also from an ecological view, the intrusion into the ecosystem is much less aggressive than present systems because it would require no restriction of natural waterways, or huge, expensive, and unnatural reservoirs. The dams that create damaging backwaters would be unnecessary, eliminating the inherent problems of such practices.

The basic design shows a device that could control a freestanding head of water with a total downward mass of several hundred or more tons. It would utilize this mass almost entirely to generate electricity. The flow of the mass would be under constant control, and would only require acceleration in order to replace the water that had most of the gravitational energy removed in the process of generation.

The nature of energy to elevation is a somewhat linear equation at ground level elevations. Any mass above sea level has an inherent energy level. Mother nature constantly renews this source in the form of gravitational forces. Mother nature changes the actual level of the seas every second of the day, all over our planet. This device allows us to tap into this huge resource with little possibility of endangering the natural processes.

### DESCRIPTION OF THE PREFERRED EMBODIMENTS

Referring now to the drawings, wherein like reference numerals and characters designate corresponding parts throughout the view. This device is designed to capture and use gravitational force exerted on a mass using elevation changes in high and low tides caused by the gradational pull of the Earths moon and the Sun.

The mechanics of this process are relatively simple, and depend entirely on the process described below.

The drawing shows two individual masses with differing densities that behave differently when floated in a fluid, such as salt water in this example.

### DESCRIPTION OF DRAWING COMPONENTS IS AS FOLLOWS

The masses in this example will assume a weight of 50 tons for mass “A” and a lessor amount for mass “B”. The masses would be sealed from water. The body mass of mass “A” would be just sufficient to achieve a slightly positive buoyancy. Mass “B” would be constructed as light as possible to achieve maximum buoyancy The installation would be in an ocean access area where high tides develop, or where elevated water is easily accessible, Lake Erie to Lake Ontario for example. In this example, we will use the Bay of Fundy off the coast of Nova Scotia, where tide levels change as much as 50 feet twice a day. As the tide rises, Mass “B” would produce a high lift force due to its high buoyancy. As load was applied to the upper main drive shaft on a generation unit, Mass “B” would sink into the water providing a vertical drive force. The further this mass was forced to sink into the water, the more energy would be transferred to the output shaft. This output would be geared to convert a large slow moving mass of energy to a faster moving, lighter mass, armature windings in a generator for example. Increasing the generator load would cause the mass to sink lower in the water. The load output could increase to the point the mass becomes entirely submerged, a full load condition. The rotational speed of the shaft would be controlled using control valve braking, for example, saving the output energy. The mass would be allowed to submerge in order to maintain pressure on the system during stagnant high tide periods. While Mass “B” is creating output power, mass “A” is simply floating to the top tide level. At top level, Mass “A” would lock onto the drive chains and would hang full weight on the drive assembly as tide recedes. This hanging mass would then insert its developed gravitational pull into the system, taking over the energy input, allowing Mass “B” to disengage, and follow the tide to its lower home position at low tide. This process is similar to the old style chain wound cuckoo clocks except it uses the flotation and gravitational effects on a device to ‘rewind’ the system. As the cycle progresses, you have a constant controlled output to the generator device. This would best be controlled numerically with a computer to insure balanced outputs through tidal changes. Output levels of this system are relatively proportionate to tidal level changes as well as mass float sizes. In other words, a larger mass float with less elevation change would have the same power output potential as a smaller mass on a higher tidal change.

In short, the flotation of mass “B” powers tide rise output, and the gradational force on Mass “A” powers the tide out cycle. Mass “A” is reset on in tide, and Mass “B” is reset on tide out. This system has almost no negative impact on surrounding environmental conditions, unlike present hydro and fossil fuel systems. It also can be utilized in many more locations than traditional hydro systems.

Also, this system would function in an elevated water system such as the case of the Niagara Escarpment where the device could be placed between Lake Erie and Lake Niagara. The elevation difference is in excess of 50 feet at this location. Any elevation difference would provide power, however greater elevation differences would have the most output per gallon of water.

1. A process for generating electricity, comprising:
(a) A dual vertical column enclosure erected in relation to a tidal effect in which the lower portions have an altitudinal relationship to a low tide level, and the upper column portions have a relationship positioned above that local high tide level.
(b) A hydraulic operating system designed to control the forces exerted by developing or decline of a column of tidal water with the ability to power an electric generator system, using a reciprocating, self-resetting device.
(c) The system would incorporate control devices, typically valves, used to control the premature decay of either state of the water columns holding the levels as needed in relationship to system design, with rise or fall of the tide.
(d) A power-generating device attached to the mechanical output of the tidal driven outputs mentioned above, with the intention of using said forces to generate an electrical or mechanical output, with the intention of providing a useable energy.
